(19) United States
(12) Patent Application Publication
(10) Pub. No.: US 2009/0160748 A1
(43) Pub. Date: Jun. 25, 2009

(54) LIQUID CRYSTAL DISPLAY DEVICE

(76) Inventors: Yohei KIMURA, Ishikawa-gun (JP); Takamitsu FUJIMOTO, Ishikawa-gun (JP); Junichi KOBAYASHI, Nomi-gun (JP); Takaharu OGINO, Ishikawa-gun (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/335,018

(22) Filed: Dec. 15, 2008

(30) Foreign Application Priority Data
Dec. 18, 2007 (JP) 2007-326192

(51) Int. Cl. G09G 3/36

(52) U.S. Cl. 345/94

(57) ABSTRACT

A liquid crystal display device, which is configured such that a liquid crystal layer is held between a pair of substrates, includes a scanning line which extends in a row direction of pixels, a signal line which extends in a column direction of the pixels, a pixel electrode which is disposed in association with each of the pixels and includes a slit, a first common electrode which is opposed to the pixel electrode via an interlayer insulation film, and a second common electrode which extends in parallel to the slit and is disposed adjacent to the pixel electrode in the same layer as the pixel electrode.

### CROSS-REFERENCE TO RELATED APPLICATIONS

This application is based upon and claims the benefit of priority from prior Japanese Patent Application No. 2007-326192, filed Dec. 18, 2007, the entire contents of which are incorporated herein by reference.

### BACKGROUND OF THE INVENTION

1. Field of the Invention

The present invention relates generally to a liquid crystal display device, and more particularly to a liquid crystal display device which is configured to have a pixel electrode and a common electrode on one of substrates that constitute a liquid crystal display panel.

2. Description of the Related Art

In recent years, flat-panel display devices have vigorously been developed, and liquid crystal display device, above all, have attracted attention because of advantages of light weight, small thickness and low power consumption. In particular, in an active matrix liquid crystal display device in which a switching element is provided in each of pixels, attention has been paid to the structure which makes use of a transverse electric field (including a fringe electric field) of an in-plane switching (IPS) mode or a fringe field switching (FFS) mode (see, for instance, Jpn. Pat. Appln. KOKAI Publication No. 2005-107535 and Jpn. Pat. Appln. KOKAI Publication No. 2006-139295).

The liquid crystal display device of the IPS mode or FFS mode includes a pixel electrode and a common electrode which are formed on an array substrate, and liquid crystal molecules are switched by a transverse electric field that is substantially parallel to the major surface of the array substrate. In addition, polarizer plates, which are disposed such that their axes of polarization intersect at right angles, are disposed on the outer surfaces of the array substrate and the counter-substrate. By this disposition of the polarizer plates, the display of a black screen is realized, for example, at a time of non-application of voltage. With the application of a voltage corresponding to a video signal to the pixel electrode, the light transmittance (modulation ratio) gradually increases and the display of a white screen is realized. In this liquid crystal display device, the liquid crystal molecules rotate in a plane that is substantially parallel to the major surface of the substrate. Thus, since the polarization state is not greatly affected by the direction of incidence of transmissive light, there is the feature that the viewing angle dependency is low and a wide viewing angle characteristic is obtained.

In particular, in the FFS mode liquid crystal display device, the pixel electrode is disposed to be opposed to the common electrode via an interlayer insulation film. The pixel electrode has a slit which is opposed to the common electrode. The liquid crystal molecules are driven by an electric field which is produced between the pixel electrode and the common electrode via the slit.

In the pixel electrode having this shape, no electric field is generated in a region where the slit is not formed, in particular, in a peripheral region of the pixel electrode. In such a region where the electric field is not generated, the liquid crystal molecules are not driven (i.e. the alignment of liquid crystal molecules does not vary from the rubbing direction). Consequently, at the time of voltage application, the modulation ratio of light passing through the liquid crystal layer does not vary. Thus, there is a demand for an improvement of the transmittance of the liquid crystal display panel, that is, an improvement of the aperture ratio of each of the pixels.

### BRIEF SUMMARY OF THE INVENTION

The object of the present invention is to provide a liquid crystal display device which can improve the transmittance and can display an image with good display quality.

According to an aspect of the present invention, there is provided a liquid crystal display device which is configured such that a liquid crystal layer is held between a pair of substrates, comprising: a scanning line which extends in a row direction of pixels; a signal line which extends in a column direction of the pixels; a pixel electrode which is disposed in association with each of the pixels and includes a slit; a first common electrode which is opposed to the pixel electrode via an interlayer insulation film; and a second common electrode which extends in parallel to the slit and is disposed adjacent to the pixel electrode in the same layer as the pixel electrode.

The present invention can provide a liquid crystal display device which can improve the transmittance and can display an image with good display quality.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 schematically shows the structure of a liquid crystal display device of a liquid crystal mode which makes use of a transverse electric field according to an embodiment of the present invention;

FIG. 2 is a cross-sectional view that schematically shows the structure of the array substrate, which is applied to the liquid crystal display device shown in FIG. 1;

FIG. 3 is a plan view that schematically shows the structure of one pixel of the array substrate, which is applied to the liquid crystal display device shown in FIG. 1;

FIG. 4A is a plan view that schematically shows the structure of the pixel of the array substrate in the embodiment;

FIG. 4B is a view that schematically shows a cross-sectional structure of the array substrate, taken along line A-B in FIG. 4A;

FIG. 4C is a view that schematically shows a cross-sectional structure of a liquid crystal display panel when the array substrate shown in FIG. 4A is cut along line C-D in FIG. 4A;

FIG. 5A is a plan view that schematically shows the structure of a pixel of an array substrate in a comparative example;

FIG. 5B is a view that schematically shows a cross-sectional structure of a liquid crystal display panel when the array substrate shown in FIG. 5A is cut along line A-B in FIG. 5A;

FIG. 6A is a plan view that schematically shows the structure of a pixel of an array substrate in a modification of the embodiment; and

FIG. 6B is a view that schematically shows a cross-sectional structure of the array substrate, taken along line A-B in FIG. 6A.

### DETAILED DESCRIPTION OF THE INVENTION

A liquid crystal display device according to an embodiment of the present invention will now be described with reference to the accompanying drawings. An FFS mode liquid crystal display device is described below as an example of a liquid crystal display device of a liquid crystal mode in which a pixel electrode and a common electrode are provided on one of substrates and liquid crystal molecules are switched by using a transverse electric field (or a horizontal electric field that is substantially parallel to the substrate) that is produced between the substrates.

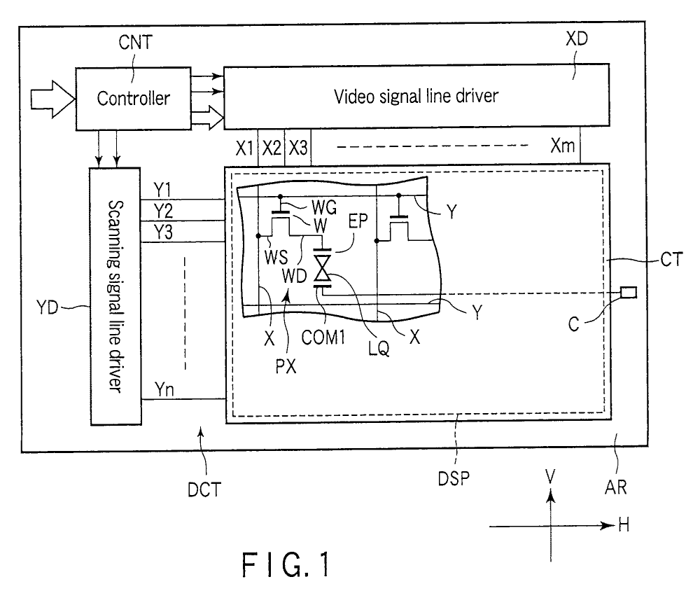

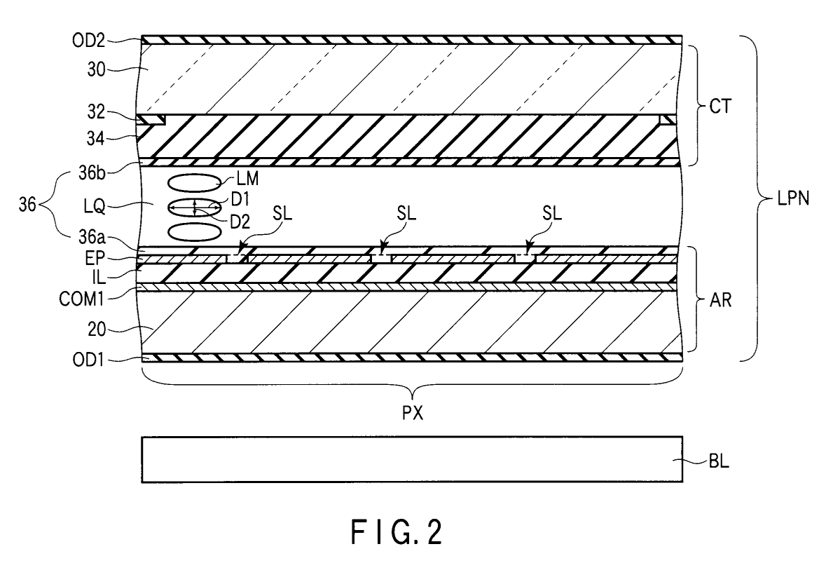

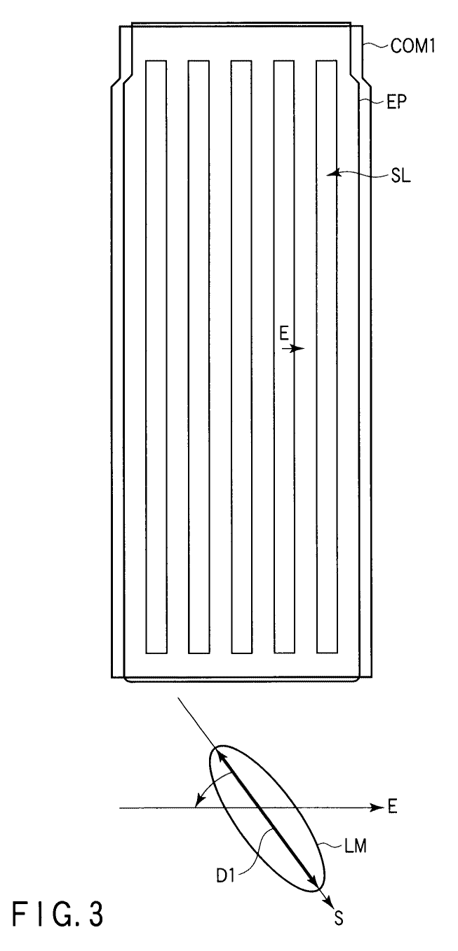

As is shown in FIG. 1, FIG. 2 and FIG. 3, the liquid crystal display device is an active matrix type liquid crystal display device, and includes a liquid crystal display panel LPN. The liquid crystal display panel LPN includes an array substrate AR, a counter-substrate CT which is disposed to be opposed to the array substrate AR, and a liquid crystal layer LQ which is held between the array substrate AR and the counter-substrate CT. This liquid crystal display device includes a display area DSP which displays an image. The display area DSP is composed of a plurality of pixels PX which are arrayed in a matrix of m×n.

The array substrate AR is formed by using an insulating substrate 20 with light transmissivity, such as a glass plate or a quartz plate. As shown in FIG. 1 and FIG. 2, the array substrate AR includes, in the display area DSP, an (m×n) number of pixel electrodes EP which are disposed in association with the respective pixels PX; an n-number of scanning lines Y (Y1 to Yn) which extend in a row direction H of the pixels PX; an m-number of signal lines X (X1 to Xm) which extend in a column direction V of the pixels PX; an (m×n) number of switching elements W which are disposed in regions including intersections between the scanning lines Y and signal lines X in the respective pixels PX; and a first common electrode COM1 which is disposed to be opposed to the pixel electrodes EP via an interlayer insulation film IL.

The array substrate AR further includes, in a driving circuit region DCT around the display area DSP, at least a part of a scanning line driver YD which is connected to the n-number of scanning lines Y, and at least a part of a signal line driver XD which is connected to the m-number of signal lines X. The scanning line driver YD successively supplies a scanning signal (driving signal) to the n-number of scanning lines Y on the basis of the control by a controller CNT. The signal line driver XD supplies video signals (driving signals) to the m-number of signal lines X on the basis of the control by the controller CNT at a timing when the switching elements W of each row are turned on by the scanning signal. Thereby, the pixel electrodes EP of each row are set at pixel potentials corresponding to the video signals that are supplied via the associated switching elements W.

Each of the switching elements W is composed of, e.g. a thin-film transistor. The semiconductor layer of the switching element W can be formed of, e.g. polysilicon or amorphous silicon. A gate electrode WG of the switching element W is connected to the scanning line Y (or the gate electrode WG is formed integral with the scanning line Y). A source electrode WS of the switching element W is connected to the signal line X (or the source electrode WS is formed integral with the signal line X) and is put in contact with a source region of the semiconductor layer. A drain electrode WD of the switching element W is connected to the pixel electrode EP and is put in contact with a drain region of the semiconductor layer.

The first common electrode COM1 is disposed, for example, in each of the pixels PX, and is electrically connected to a common wiring line C to which a common potential is supplied. The first common electrode COM1 is covered with the interlayer insulation film IL. The pixel electrode EP is disposed on the interlayer insulation film IL so as to be opposed to the first common electrode COM1.

As shown in FIG. 2 and FIG. 3, the pixel electrode EP is provided with a plurality of slits SL which are opposed to the first common electrode COM1. The pixel electrode EP and first common electrode COM1 are formed of a light-transmissive, electrically conductive material such as indium tin oxide (ITO) or indium zinc oxide (IZO). That surface of the array substrate AR, which is in contact with the liquid crystal layer LQ, is covered with an alignment film 36a.

On the other hand, the counter-substrate CT is formed by using an insulating substrate 30 with light transmissivity, such as a glass plate or a quartz plate. Specifically, in a color-display-type liquid crystal display device, as shown in FIG. 2, the counter-substrate CT includes, on an inner surface of the insulating substrate 30, that is, on a surface opposed to the liquid crystal layer LQ, a black matrix 32 which divides the pixels PX, and a color filter layer 34 which is disposed in each pixel PX which is surrounded by the black matrix 32. In addition, the counter-substrate CT may be configured to include a shield electrode for reducing the effect of an external electric field, and an overcoat layer which is disposed with such a relatively large film thickness as to planarize irregularities on the surface of the color filter layer 34.

The black matrix 32 is disposed on the insulating substrate 30 so as to be opposed to the scanning lines Y and signal lines X and wiring portions of the switching elements W, etc., which are provided on the array substrate AR. The color filter layer 34 is disposed on the insulating substrate 30 and is formed of color resins of different colors, for example, the three primary colors of red, blue and green. The red color resin, blue color resin and green color resin are disposed in association with the red pixel, blue pixel and green pixel, respectively. That surface of the counter-substrate CT, which is in contact with the liquid crystal layer LQ, is covered with an alignment film 36b.

When the above-described counter-substrate CT and array substrate AR are disposed such that their alignment films 36a and 36b are opposed to each other, a predetermined gap is created by spacers (not shown) which are disposed therebetween. The liquid crystal layer LQ is formed of a liquid crystal composition including liquid crystal molecules LM which are sealed in the gap that is created between the alignment film 36a of the array substrate AR and the alignment film 36b of the counter-substrate CT. The liquid crystal molecules LM included in the liquid crystal layer LQ are aligned by restriction forces that are caused by the alignment film 36a and alignment film 36b. Specifically, at a time of no electric field, that is, when there is no potential difference between the pixel electrode EP and the first common electrode COM1 (i.e. when no electric field is generated between the pixel electrode EP and the first common electrode COM1), the liquid crystal molecules LM are aligned such that their major-axis direction D1 is parallel to a rubbing direction S of the alignment film 36a and alignment film 36b.

The liquid crystal display device includes an optical element OD1 which is provided on one of outer surfaces of the liquid crystal display panel LPN (i.e. that surface of the array substrate AR, which is opposite to the surface thereof that is in contact with the liquid crystal layer LQ), and an optical element OD2 which is provided on the other outer surface of the liquid crystal display panel LPN (i.e. that surface of the counter-substrate CT, which is opposite to the surface thereof that is in contact with the liquid crystal layer LQ). Each of the optical elements OD1 and OD2 includes a polarizer plate, and, for example, a normally black mode, in which the transmittance of the liquid crystal panel LPN decreases to a minimum (i.e. a black screen is displayed) at the time of no electric field, is realized.

Further, the liquid crystal display device includes a backlight unit BL which is disposed on the array substrate AR side of the liquid crystal display panel LPN.

In this liquid crystal display device, as shown in FIG. 3, when a potential difference is produced between the pixel electrode EP and the first common electrode COM1 (i.e. at a voltage application time when a voltage of a potential that is different from a common potential is applied to the pixel electrode EP), an electric field E is generated between the pixel electrode EP and the first common electrode COM1. At this time, the liquid crystal molecule LM is driven such that its major-axis direction D1 is oriented from the rubbing direction S to a direction parallel to the electric field E. If the major-axis direction D1 of the liquid crystal molecule LM varies from the rubbing direction S, the modulation ratio relating to the light passing through the liquid crystal layer LQ varies.

Accordingly, part of backlight, which emanates from the backlight unit BL and passes through the liquid crystal display panel LPN, passes through the second optical element OD2, and thus a white screen is displayed. In short, the transmittance of the liquid crystal display panel LPN varies depending on the magnitude of the electric field E. In the liquid crystal mode which makes use of a transverse electric field, the backlight is selectively transmitted in this manner, and an image is displayed.

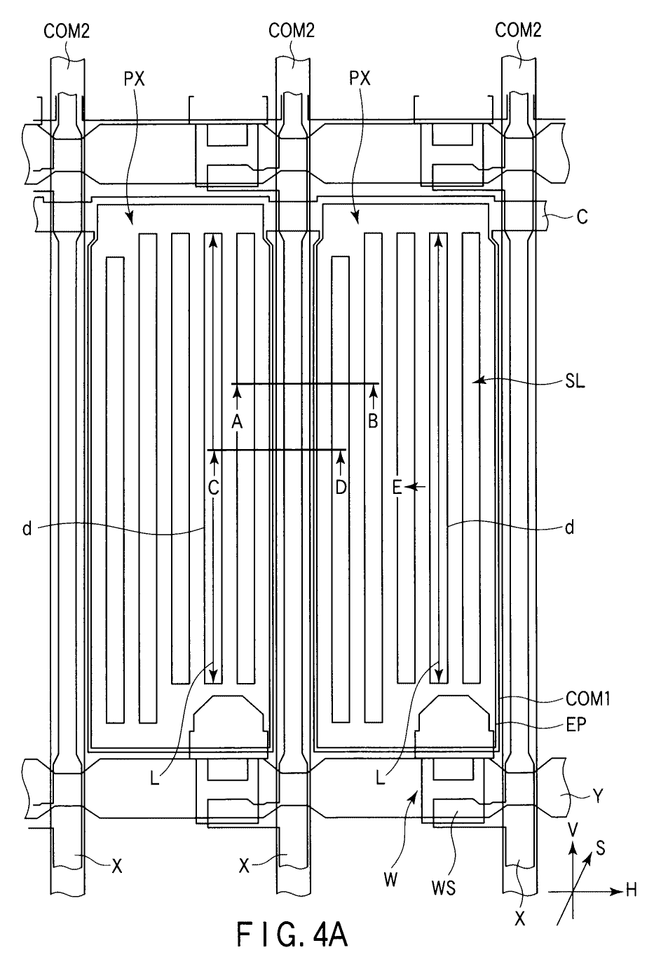

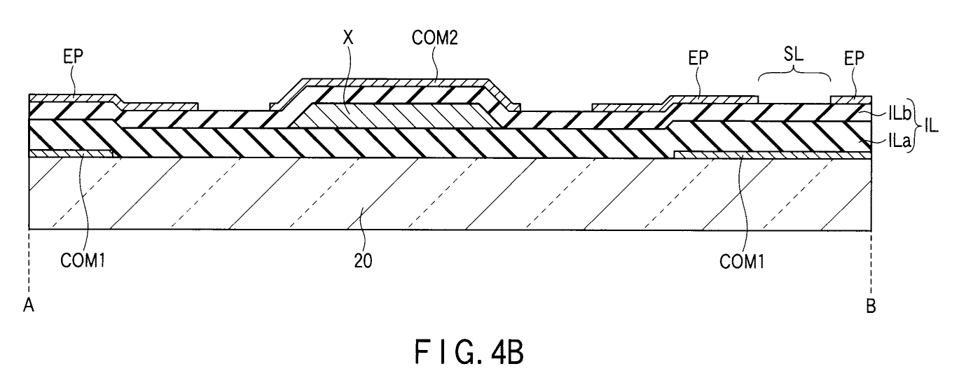

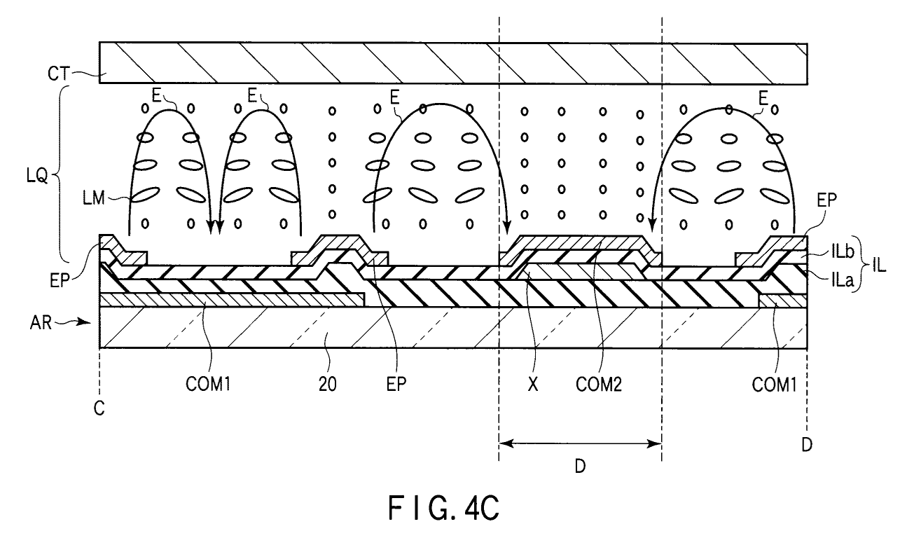

In particular, in the present embodiment, the liquid crystal display device includes a second common electrode COM2 which is disposed in the display area DSP. The second common electrode COM2 extends in parallel to the long axis L of the slit SL of the pixel electrode EP or the signal line X. In an example shown in FIG. 4A, the slit SL is formed such that its long axis L is parallel to the column direction V. The slit SL is formed, for example, in a rectangular shape. The long side d of the slit SL is parallel to the long axis L. The plural slits SL are arranged in the row direction H. Specifically, in the example shown in FIG. 4A, the second common electrode COM2 is disposed to extend in a direction parallel to the long axis L of the slit SL, that is, in the column direction V.

The second common electrode COM2 is disposed in the same layer as the pixel electrode EP, and is adjacent to the pixel electrode EP. The pixel electrode EP and the second common electrode COM2 are spaced apart, and their side edges are opposed to each other. A gap, which extends in the column direction V, like the slit SL, is formed between the pixel electrode EP and the second common electrode COM2. Specifically, the pixel electrode EP and second common electrode COM2 are electrically insulated. The first common electrode COM1 and second common electrode COM2 are electrically connected via a contact hole (not shown). Thus, the first common electrode COM1 and second common electrode COM2 have the same potential and are electrically connected to the common wiring line C.

As is shown in FIG. 4B, in the array substrate AR, the first common electrode COM1 is disposed on the insulating substrate 20. The first common electrode COM1 and the insulating substrate 20 are covered with a first insulation film ILa of the interlayer insulation film IL. The signal line X is disposed on the first insulation film ILa. The signal line X and the first insulation film ILa are covered with a second insulation film ILb of the interlayer insulation film IL. The second common electrode COM2, as well as the pixel electrode EP, is disposed on the second insulation film ILb.

The first common electrode COM1 and second common electrode COM2 are electrically connected. Thus, when a potential difference is created between the pixel electrode EP, and the first common electrode COM1 and second common electrode COM2, an electric field E is produced between the pixel electrode EP and first common electrode COM1 via the slit SL in a direction perpendicular to the long side d of the slit SL, that is, in the row direction H. At the time of voltage application, in the region where the slit SL is formed, the liquid crystal molecule LM is oriented from the rubbing direction S to a direction parallel to the electric field E. In this case, in the major plane of the array substrate AR, the rubbing direction S is set to be a direction crossing the column direction V.

In addition, at the time of voltage application, an electric field E is produced at peripheral edges of the pixel electrode EP, like the region where the slit SL is formed. Specifically, as shown in FIG. 4C, the electric field E is produced in the gap between the second common electrode COM2 and the pixel electrode EP, in the region where the slit SL is not formed, in particular, at the side edge of the pixel electrode EP along the column direction V, that is, in the region near the signal line X.

In this gap, the electric field E is produced in a direction perpendicular to that side edge of the pixel electrode EP, which is opposed to the second common electrode COM2, that is, in the row direction H. Thus, at the time of voltage application, also at the peripheral edges of the pixel electrode EP, the liquid crystal molecules LM are oriented from the rubbing direction S to the direction parallel to the electric field E. The electric field E, which is produced in the peripheral region of the pixel electrode EP, is parallel to the electric field E in the region where the slit SL is formed.

In the present embodiment, therefore, the peripheral edges of the pixel electrode EP, in particular, the region along the signal line, can be made effective, and the transmittance of the liquid crystal display panel LPN at the time of voltage application can be improved.

The second common electrode COM2 extends in parallel to the slit SL which has the long axis L that is parallel to the column direction V, and the second common electrode COM2 may be disposed to be opposed to the signal line X or may be disposed between the signal line X and the pixel electrode EP (i.e. in such a manner as not to overlap the signal line X immediately thereabove). As shown in FIG. 4A and FIG. 4B, the second common electrode COM2 is disposed to be opposed to the signal line X via the second insulation film ILb. In this case, the non-effective region between the pixels can be reduced. In other words, the distance between the pixel electrodes EP, which neighbor with the signal line X interposed, can be decreased. Therefore, higher fineness can be realized.

In the case where the signal line X is disposed between the insulating substrate 20 and the first insulation film ILa and the second common electrode COM2 is disposed on the second insulation film ILb, the first insulation film ILa and second insulation film ILb are present between the second common electrode COM2 and the signal line X. Specifically, it should suffice if at least one insulation film is present between the second common electrode COM2 and the signal line X.

The second common electrode COM2 is formed of the same material as the pixel electrode EP. Specifically, after a film of a light-transmissive, electrically conductive material, such as ITO or IZO, is formed on the interlayer insulation film IL, the second common electrode COM2 is patterned at the same time as patterning the pixel electrode EP. Thereby, the pixel electrode EP and second common electrode COM2 can be formed in the same step. Since no additional fabrication step is needed for pattering the second common electrode COM2, the fabrication cost can be reduced. In the meantime, another fabrication step may be added, and the second common electrode COM2 may be formed in a step different from the step of forming the pixel electrode EP. In this case, the second common electrode COM2 may be formed of a material different from the material of the pixel electrode EP.

The advantageous effects of the structure of the present embodiment will be explained, in comparison to a comparative example.

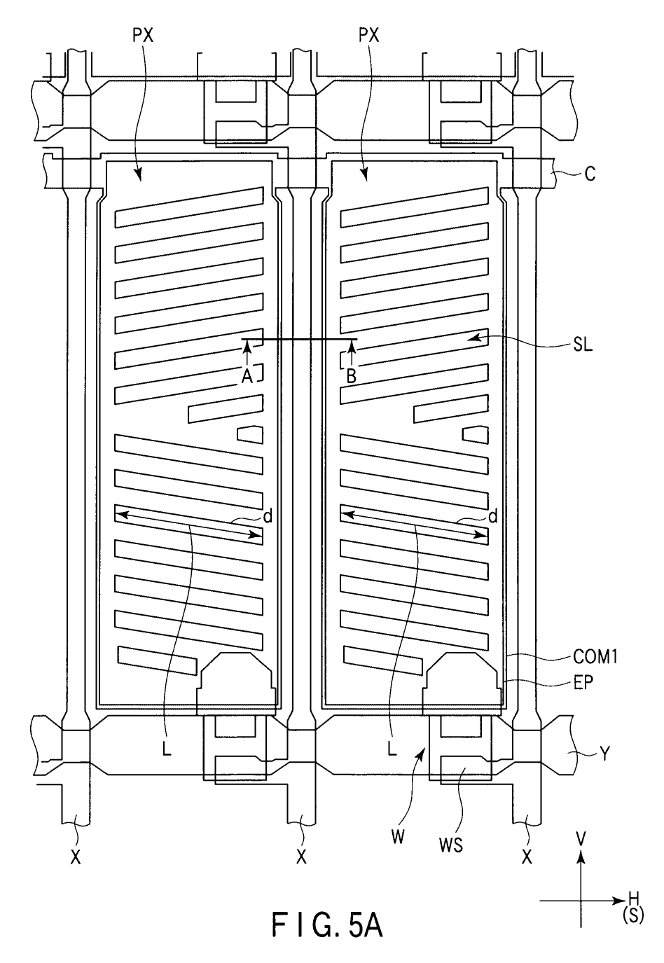

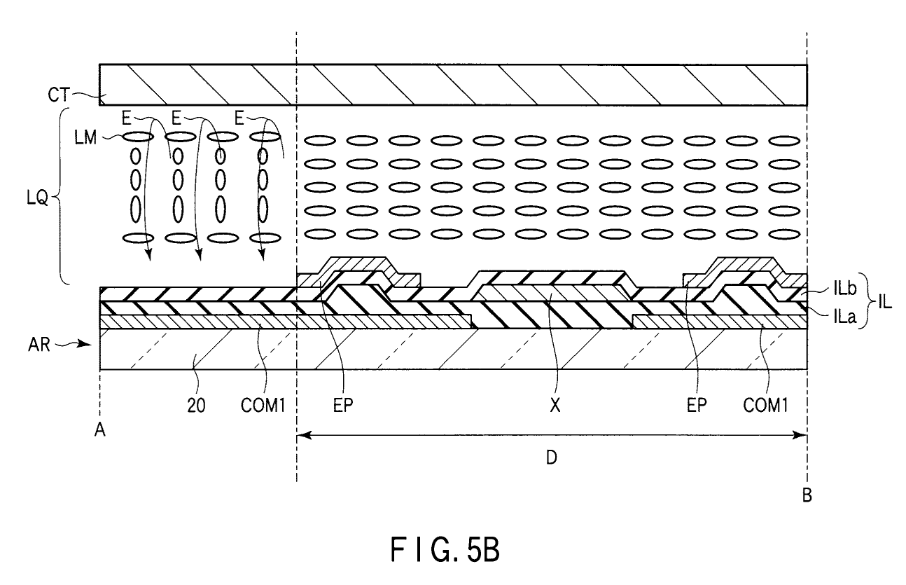

In a comparative example shown in FIG. 5A, the pixel electrode EP includes a plurality of slits SL which are formed with inclinations in two directions, relative to the row direction H. Specifically, the slits SL are formed such that their long axes L are inclined to the row direction H. The slit SL is formed, for example, in a parallelogrammatic shape. The long side d of the slit SL is parallel to the long axis L. The plural slits SL are arranged in the column direction V that is perpendicular to the row direction H. In this case, in the major plane of the array substrate AR, the rubbing direction S agrees with the row direction H.

If a potential difference is produced between the pixel electrode EP and the first common electrode COM1, an electric field E is produced via the slit SL in a direction perpendicular to the long side d thereof. By this electric field E, the liquid crystal molecule LM is driven and is oriented from the rubbing direction S to a direction parallel to the electric field E. Specifically, at the time of voltage application, in the region where the slit SL is formed, the liquid crystal molecule LM is oriented from the rubbing direction S to the direction parallel to the electric field E.

On the other hand, in the region where the slit SL is not provided, in particular, at the peripheral edge of the pixel electrode EP, even if a potential difference is created between the pixel electrode EP and the first common electrode COM1, no electric field E is generated. As shown in FIG. 5B, for example, the electric field E is not produced in a region D of the pixel electrode EP near the signal line X. In this region D, since the alignment of the liquid crystal molecule LM does not vary from the rubbing direction S, the modulation ratio relating to the light passing through the liquid crystal layer LQ does not vary. In short, the region D becomes a non-effective region.

By contrast, the liquid crystal display device of the present embodiment includes the second common electrode COM2 which extends in parallel to the long axis L of the slit SL of the pixel electrode EP and is adjacent to the pixel electrode EP. The second common electrode COM2 is electrically connected to the first common electrode COM1 which is opposed to the pixel electrode EP via the interlayer insulation film IL.

Accordingly, when a potential difference is created between the pixel electrode EP and the first common electrode COM1, the electric field E is also produced between the pixel electrode EP and the second common electrode COM2 at the peripheral edge of the pixel electrode EP, where the slit SL is not provided. The electric field E, which is produced in the region where the slit is not provided, is parallel to the electric field that is produced between the pixel electrode EP and the first common electrode COM1 via the slit SL. Thus, at the time of voltage application, the alignment direction of the liquid crystal molecules LM at the peripheral edge of the pixel electrode EP agrees with the alignment direction of the liquid crystal molecules LM in the region where the slit SL is provided.

As has been described above, the peripheral edges of the pixel electrode EP can be made effective, and the width of the non-effective region D can be made less than in the comparative example. Thereby, the aperture ratio and transmittance of the liquid crystal display panel LPN can be improved.

It was confirmed that, compared to the transmittance in the comparative example of FIG. 5A at the time of application of a maximum voltage (i.e. at the time of display of a white screen), the transmittance in the present embodiment shown in FIG. 4A and FIG. 4B at the time of application of the same voltage was 1.2 times higher and was improved.

Next, a modification of the present embodiment is described.

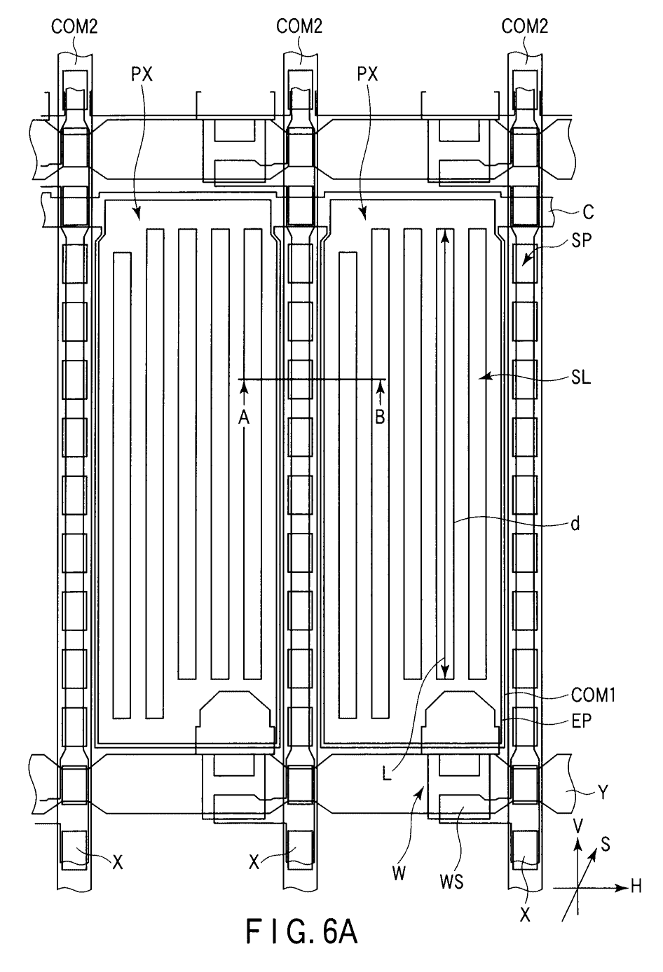

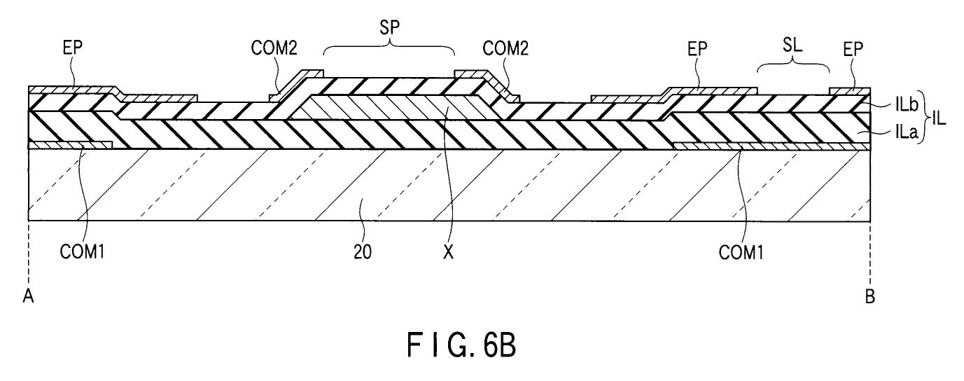

A liquid crystal display device in this modification, like the present embodiment, includes the second common electrode COM2. As shown in FIG. 6A, the slit SL of the pixel electrode EP is formed such that its major axis L is parallel to the column direction V. The second common electrode COM2 extends in parallel to the long axis L of the slit SL. In addition, as shown in FIG. 6B, like the above-described embodiment, the second common electrode COM2 is formed in the same layer as the pixel electrode EP. The second common electrode COM2 is disposed to be opposed to the signal line X via the second insulation film ILb.

Further, in the modification, as shown in FIG. 6A and FIG. 6B, the second common electrode COM2 includes a plurality of openings SP. Specifically, the opening portions SP are formed to be opposed to the signal line X.

In the opening SP, no capacitance is formed between the signal line X and the second common electrode COM2. Specifically, by forming the opening SP, the capacitance occurring between the signal line X and the second common electrode COM is decreased. Hence, an increase in power consumption of the liquid crystal display device can be suppressed. Therefore, in this modification, the aperture ratio and transmittance of the liquid crystal display panel LPN at the time of voltage application can be improved, and the power consumption of the liquid crystal display device can be decreased.

As has been described above, according to the liquid crystal display device of the present embodiment, the transmittance can be improved, and an image with good display quality can be displayed.

The present invention is not limited directly to the above-described embodiment. In practice, the structural elements can be modified and embodied without departing from the spirit of the invention. Various inventions can be made by properly combining the structural elements disclosed in the embodiment. For example, some structural elements may be omitted from all the structural elements disclosed in the embodiment. Furthermore, structural elements in different embodiments may properly be combined.

For example, in the above-described embodiment, the pixel electrode EP includes the slit SL that is parallel to the signal line X, and the second common electrode COM2, which is parallel to the slit SL, is disposed in parallel to the signal line X. In the case of a structure in which the pixel electrode EP includes a slit SL that is parallel to the scanning line Y, if the second common electrode COM2, which is parallel to the slit SL, is disposed in parallel to the scanning line Y, the peripheral edge of the pixel electrode EP, which is opposed to the scanning line Y, can be made effective, and the same advantageous effects as with the above-described embodiment can be expected.

What is claimed is:

1. A liquid crystal display device which is configured such that a liquid crystal layer is held between a pair of substrates, comprising:
a scanning line which extends in a row direction of pixels;
a signal line which extends in a column direction of the pixels;
a pixel electrode which is disposed in association with each of the pixels and includes a slit;
a first common electrode which is opposed to the pixel electrode via an interlayer insulation film; and
a second common electrode which extends in parallel to the slit and is disposed adjacent to the pixel electrode in the same layer as the pixel electrode.

2. The liquid crystal display device according to claim 1, wherein the slit is formed in parallel to the column direction.

3. The liquid crystal display device according to claim 1, wherein the pixel electrode and the second common electrode are formed of the same electrically conductive material.

4. The liquid crystal display device according to claim 1, wherein the second common electrode is opposed to the signal line via an insulation film.

5. The liquid crystal display device according to claim 4, wherein the second common electrode includes an opening which is opposed to the signal line.
